(19) United States
(12) Patent Application Publication
(10) Pub. No.: US 2016/0162488 A1
(43) Pub. Date: Jun. 9, 2016

(54) METHOD AND SYSTEM FOR SCORING ON-LINE PROFILES

(71) Applicant: Enrico L. CORRADI, Atlanta, GA (US)

(72) Inventor: Enrico L. Corradi, Atlanta, GA (US)

(21) Appl. No.: 14/907,287

(22) PCT Filed: Jul. 24, 2014
(86) PCT No.: PCT/US14/48029

§ 371 Date: Jan. 24, 2016

Related U.S. Application Data
(60) Provisional application No. 61/857,927, filed on Jul. 24, 2013.
(60) Provisional application No. 61/898,302, filed on Oct. 31, 2013.

(51) Int. Cl. G06F 17/30; G06Q 50/00; G06Q 10/10

(52) U.S. Cl. CPC G06F 17/3053; G06F 17/30867; G06Q 10/1053; G06Q 50/01

(57) ABSTRACT

A system for scoring an on-line profile and/or personality traits of a first subscriber includes a subsystem for receiving and reviewing content and/or ratings submitted by a second subscriber, a publishing system configured to publish the content based on an election to publish by the first subscriber; and a scoring subsystem configured to calculate a score for the on-line profile and/or personality traits of the first subscriber based at least in part on the election made by the first subscriber. The scoring subsystem can continuously update the on-line profile and personality traits scores as content is received and publishing options are elected. Feedback related to published content and ratings can be received and used in the calculation of on-line profile and personality trait scores.

### CROSS REFERENCE TO RELATED PATENT APPLICATION

This application claims priority to U.S. Patent Application No. 61/857,927 filed Jul. 24, 2013, and U.S. Patent Application No. 61/898,302 filed Oct. 31, 2013, each of which is herein incorporated by reference in its entirety.

### TECHNICAL FIELD

Embodiments of the disclosure are directed to applications involving social media, and more particularly, to a system and method for generating and scoring on-line system profiles.

### BACKGROUND

Technology now has enabled many people to create a first impression on-line and then to continue dialog and interaction with others in that fashion. Be it with neighbors, co-workers, educational institutions, or employers, among others, and including friends, co-workers and other acquaintances of the foregoing, various social media have enabled individuals to have an on-line presence personality that theoretically matches their physical presence and personality. Sites like Facebook®, Twitter®, Instagram®, LinkedIn® and others permit one-to-one and group interactions.

Some social media programs, such as Facebook, for example, permit not only a subscriber to create his/her on-line profile, but also permit friends of the subscriber to post their own comments to that subscriber's profile. As such, a viewer is able to obtain a broader and perhaps deeper picture of the subscriber's personal life.

However, there is nothing within the existing social media programs that rate the accuracy or truthfulness of the subscriber's profile. One subscriber may be brutally honest in his/her profile, while another may stretch the truth, while yet another may actually lie about himself or herself. For example, pictures and anecdotes depicting a subscriber having world-class athleticism or scholarship may be totally accurate or may, in fact, be entirely false or misleading. A reader may have no way of knowing whether the information is false.

Moreover, social media do not adequately protect a subscriber's personal information. Anyone may be able to access such information and most are able to publish false or misleading information, or even truthful information that the subscriber does not wish to share. The subscriber has little or no control about what others may post about him or her.

A similar problem exists with respect to consumers and their interactions with businesses. On-line reviews from customers of those businesses are often helpful to other consumers. Web searches return all types of information relating to the search. However, there is no way to judge the authenticity of such reviews. For example, the reviews may be generated by employees of the business and therefore overly generous in their praise. Alternatively, the review may be generated by a competitor of the business and therefore be unduly harsh or entirely false or misleading. Even “neutral” third party consumer review sites cannot vouch for the authenticity or accuracy of the reviews posted on its site.

More recently, there have been systems introduced that help manage the reputation of a subscriber. It is believed that these systems manage search results—for a fee—rather than affirm the accuracy of the on-line data about the subscriber.

Accordingly, there is a need to create a social media system in which the truth and veracity of a subscriber profile may be scored and documented in such a way that readers of the profile will be able to understand the reliability of the information contained therein.

### SUMMARY

The following presents a simplified summary that describes some aspects or embodiments of the subject disclosure. This summary is not an extensive overview of the disclosure. Indeed, additional or alternative embodiments of the subject disclosure may be available beyond those described in the summary.

The disclosure relates to a system for scoring an on-line profile of a first subscriber includes a subsystem for receiving and reviewing content submitted by a second subscriber, a publishing system configured to publish the content based on an election to publish by the first subscriber; and

a scoring subsystem configured to calculate a score for the on-line profile of the first subscriber based at least in part on the election made by the first subscriber.

### BRIEF DESCRIPTION OF THE DRAWINGS

The following description is better understood when read in conjunction with the appended drawings.

FIG. 1 is an architecture diagram of an exemplary system of an embodiment of the disclosure.

FIG. 2 is a functional block diagram of an exemplary system of an embodiment of the disclosure.

FIG. 3 is a flow chart of a method in accordance with an embodiment of the disclosure.

FIG. 4 is a representation of an exemplary user screen in accordance with an embodiment of the disclosure.

FIG. 5A is a flow chart of a method in accordance with an embodiment of the disclosure.

FIG. 5B is a graphical representation of components of an equation used to calculate a profile score.

FIG. 5C is a graphical representation of components of an equation used to calculate a profile score.

FIG. 5D is a summary of parameters used in equations for calculating a profile score.

FIG. 6A is a flow chart of a method in accordance with an embodiment of the disclosure

FIG. 6B is an illustration of an exemplary development chart in accordance with an embodiment of the disclosure.

FIG. 6C is an illustration of an exemplary development chart in accordance with an embodiment of the disclosure.

FIG. 7 is an illustration of an exemplary personality data chart in accordance with an embodiment of the disclosure.

FIG. 8 is a flow chart of a method in accordance with an embodiment of the disclosure

FIG. 9 is a functional block diagram of a mobile device in accordance with an embodiment of the disclosure.

FIG. 10 is a functional block diagram of a network device in accordance with an embodiment of the disclosure.

### DETAILED DESCRIPTION OF ILLUSTRATIVE EMBODIMENTS

Reference will now be made in detail to the various embodiments of the invention, one or more examples of which are illustrated in the figures. Each example is provided by way of explanation of the embodiment and is not meant as a limitation thereof. For example, features illustrated as part of one embodiment may be incorporated with respect to other embodiments. It is intended that any such modifications and variations are included herewith.

The disclosure relates to an on-line digital newspaper that is focused on an individual, business or other entity. For the purposes of this disclosure and for the examples cited herein, the term “individual” will be used as a non-limiting term which incorporates other entities as well. Likewise, the term “newspaper” will be used in a non-limiting manner and includes the concept of on-line profiles, articles, pictures, posts, letters, magazines, and any other content that is aggregated for viewing.

The systems and methods in the disclosure are useful across a broad range of applications, including but not limited to academia, labor, government and social applications. For example, the disclosure as it applies to academia may permit a subscriber to create a profile, develop that profile over time and have it used as a tool to select partners having similar skill sets and values, and use that profile as a reference for internships or other personal or professional growth opportunities and beyond. In other words, over time, that subscriber's profile will comprise a trust system that becomes a digital newspaper about the subscriber.

The systems and methods of the disclosure contemplate a system, including a web site and a mobile application, which enables subscribers and users to publish and share information in the form of text or other content, including pictures, videos, and other content specifically about a subscriber. All such content is subject to approval and validation by the subscriber who receives it. The publishing format may be, for example, similar to newspaper or social media, for example, a social network, a blog, a message board, or other type of publishing format. The behavior of both the writer who sends the content and the subscriber who is the recipient of the content is reflected into a score that reflects self-awareness, integrity, transparency, trust, and reliability.

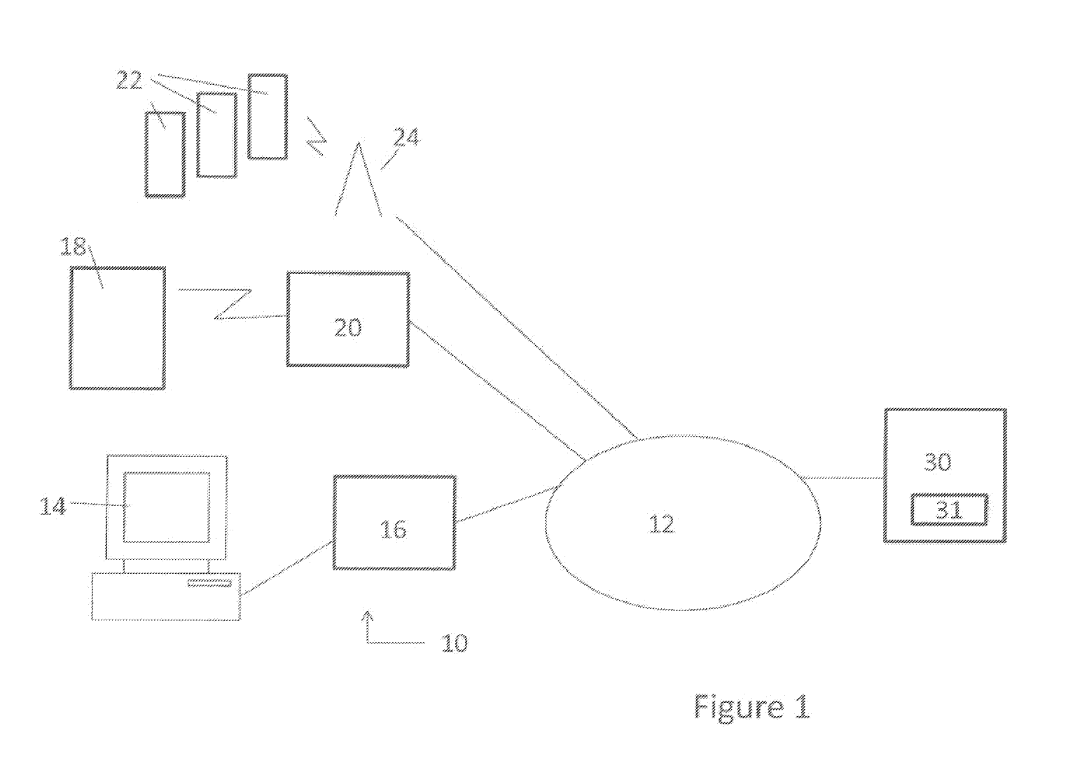

With reference to FIG. 1, there is shown an exemplary system architecture diagram in which users and subscribers of the system 10 may access the system 10. The system 10 includes a telecommunications network 12, which may, for example be the internet, an intranet, an extranet, the PSTN, a VPN, a cellular network, WiLan, WiFi, LAN, optical ring or any other type of network capable of transferring data. The network 12 may be accessible by one or more computers 14 which may, for example, be connected to the network 12 via local area network 16. The network 12 may also be accessible by one or more tablet computers 18, which may, for example, by an Apple® iPad®, Microsoft® or an Android® or other portable computing device, connected to network 12 through, for example, wireless access point 20. The network may also be accessible by one or more mobile devices 22, which may, for example, be a cellular telephone, PDA, or smartphone, connected to network 12 through cellular network 24. The network 12 also provides the interface to one or more servers 30 (e.g., hardware and/or software) on which applications may reside, including an application 31 in accordance with the present disclosure.

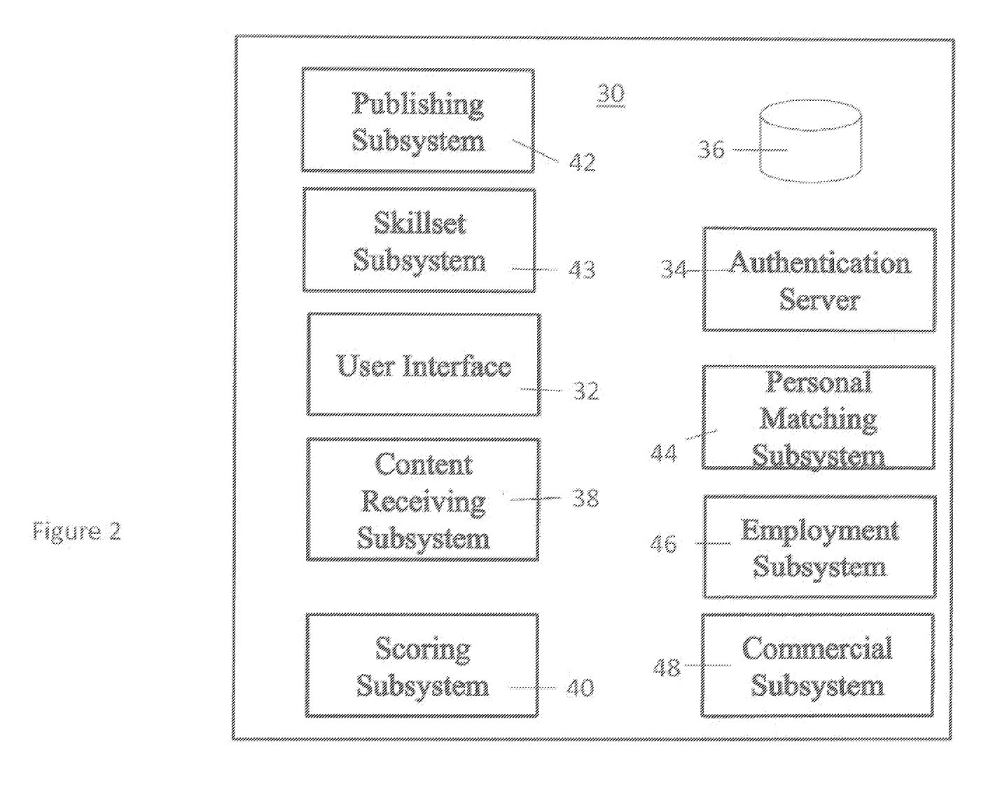

With reference to FIG. 2, the server 30 includes an application 31 for an on-line user network site which comprises the following components:
A user interface 32 which receives inputs from a user and generates outputs back to the user/
An authentication server/subsystem 34 which obtains registration information from subscribers and authenticates users accessing the system. Each subscriber has a profile and on-line authentication associated with the subscriber.
A database 36 as a repository for subscriber information and encrypted authentication information.
A content receiving subsystem 38 which receives articles or other submissions from writers designated either as anonymous or with credit to the writer.
A scoring subsystem 40 that collects subscribers' and users' behavior information and generates a score through a mathematical algorithm.
A publishing system 42 which publishes a digital newspaper including articles and other content with the approval of the subscriber.
A skillset identification subsystem 43 which lists various personality traits and personal skills to rate subscribers based on subscriber's attributes and proficiency level.
A personal matching subsystem 44 to match values and personality of subscribers with other subscribers and/or corporate values and culture or other benchmarks which may be selected by a subscriber. The personal matching subsystem 44 may take the form of either a numerical representation or a graphical representation.
An employment subsystem 46 to broker employee-employer interactions, including the ability to offer and select internships or other jobs based on personality or values or other criteria that matches the subscriber with an employer based on compatibility.
A commercial subsystem 48 wherein selected subscribers may elect to become brand advocates and access earning opportunities based on offering their on-line profile space to selected brands/products.
A system to actively teach users how to develop leadership competencies, professionalism, and competencies in general
   A way to track changes and development of those traits for individual users and groups such as teams
   A way to enable users to suggest and track behaviors that enhance the display of certain personality traits and behavioral competencies
System to coach and gather information about individuals while going through personal and professional development

It is understood that the various subsystems may or may not be located on one or more physical servers. It is also understood that the various subsystems are interconnected to enable interaction and cooperation between the various subsystems and that each subsystem may communicate with or interact with any other subsystem. Those interconnections are not explicitly shown in FIG. 2. There may also be other interconnected subsystems included in the server 30 which are not shown in FIG. 2. In that respect, FIG. 2 is not intended to be exemplary only and not intended to limit the disclosure in any manner.

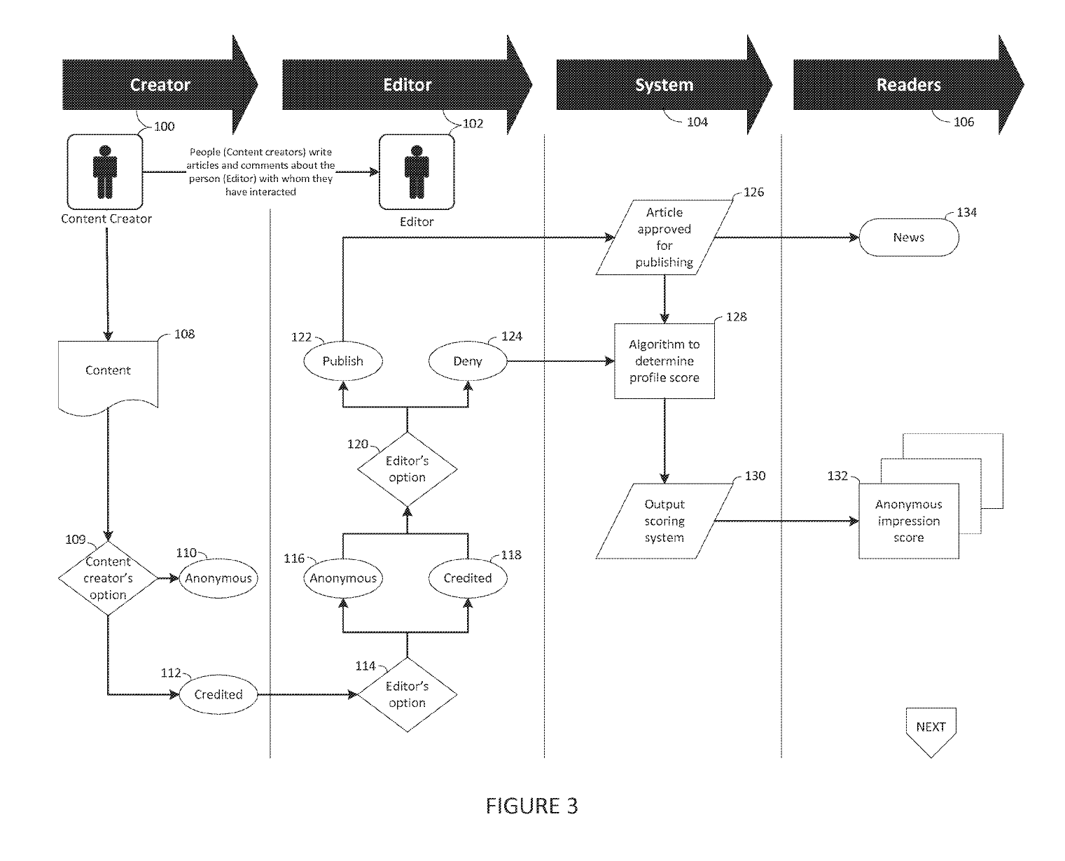

With reference to FIG. 3, there is shown a flow chart wherein certain functions are attributed to either a content creator 100, editor 102, the system 104 or readers 106. The content creator 100 typically develops content which may include, for example, articles, blogs, pictures, videos, reviews, ratings or any other type of content. The editor 102 is the person or entity about whom the content is directed. Readers 106 are the group of individuals that have access to the published newspaper about the editor 102. The term “subscribers” as used herein may encompass both content creators 100 and editors 102, and may also include readers 106. The term “users” as used herein may include content creators and readers, but not necessarily editors. However, the terms “user” and “subscriber” are provided for ease of discussion are not intended to limit the scope of the respective term. For example, the term “subscriber” can comprise or be any user, type of user, function of user, category of user, and the like, as appropriate for the example used.

Content creator 100 may write articles or develop other content at 108. At 109, the content creator 100 makes a decision to either to submit the content anonymously through step 110 or credited (i.e., attribution to the author) through step 112. The content may be submitted through the user interface 32 to the content receiving subsystem 38, with the content creator 100 authenticated by the authentication server 34. At that point, the interaction of the content creator 100 is completed with respect for that particular content created at 108 and control of the content is passed on to the editor 102.

If the content creator 100 elected to be credited, the editor 102 may elect at step 114 to proceed by overriding the content creator's 100 decision and elect to keep the content creator 100 anonymous through step 116 or follow the content creator's 100 decision and select credited through step 118. Regardless of that decision, the editor 102 then has the decision at step 120 to either publish the content at step 122 or deny publication at step 124. If the editor 102 elects to publish the content, then the earlier decision of the editor 102 with respect to anonymity or credit will be attached to that content. At that point, the editor's 102 involvement with that content is completed.

The system 104 receives articles approved for publication at step 126. The content is received by the publishing subsystem 42 and processed into, for example, a newspaper at 134 for readers 106 to view. At step 128, there is an algorithm executed by the scoring subsystem 40 to determine an impression score. This step is executed whenever content is approved for publishing at step 126 of when publication is denied by the editor 102 at step 124. After the impression score is calculated, it is outputted at 130 and then published at step 132 for readers 106 to view.

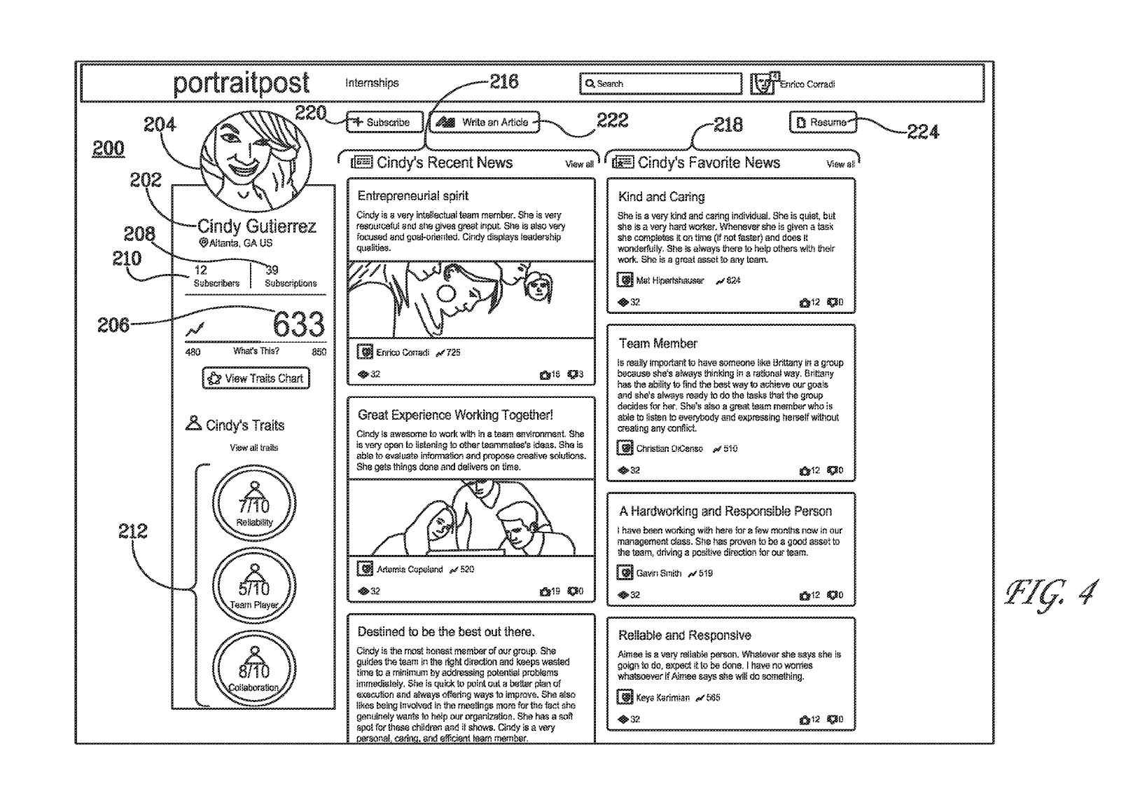

With reference to FIG. 4, there is shown an exemplary screen shot 200. The subscriber's name is shown at location 202 with the subscriber's picture shown at location 204. The subscriber's impression score is shown at location 206. The number of other subscribers' newspapers the subscriber subscribes to is indicated at location 208, while the number of subscribers of this subscriber is at location 210. At location 212 are ratings from other users of the subscriber's personality traits. Recently published articles are found at location 216, and favorite articles of the subscriber are found at location 218. Other subscribers may click on the button at 220 to subscribe to the subscriber, and they may click on the button at 222 to write an article about the subscriber. The subscriber may also click on the button at 224 to upload his or her resume. The profile page can display the number of articles written about the subscriber as well as the publishing rate of the subscriber (not shown). The profile page can also display the number of articles the subscriber has written about other subscribers as well as the publishing rate of those articles (not shown). It will be understood that the form and format of this screen shot is for exemplary purposes only and is not meant to limit the scope of the disclosure in any manner.

In operation and by way of example only, the application 31 comprises the following steps or functions:
Subscriber registration, generation of credentials, and authentication
Limited general public access may be possible, but some content or newspapers may require all visitors to have an account.
Subscribers may write and submit news with or without embedded pictures, videos, or other forms of media about other subscribers, either anonymously or with attribution,
Subscribers may receive news with or without embedded pictures, videos or other forms of media either anonymously or with attribution
Upon receipt of news from others about themselves, subscribers may confidentially evaluate the relevancy of the content before approving or denying it for publishing

As such, all of the shared information submitted to the content receiving subsystem 38 is subject to validation by the recipient subscriber prior to sending it to the publishing subsystem 42. The recipient subscribers have the ability to confirm the validity of the data published through a scoring and validation system. As part of that system, submitted articles may have an expiration date—controllable by the recipient subscriber—after which the same content provider may author another article to the same subscriber. Moreover, every interaction on the website may be tracked so as to avoid duplication of the same action (ex. view counter on an article is based on the variety of users reading it and not on how many times the same user reads it).

Other functionality of the system may include an employment subsystem 46 which may accept and publish resume information. Such information may have validation boxes that allow reviewers to uniquely check and confirm the information reported by the profile owner

A skillset subsystem 43 allows subscribers to select from a predefined list of skills, talents, personality traits, competencies, or other attributes or create their own personalized items to provide a clearer picture of themselves to their followers and allow other subscribers to do the same. As such, subscribers and their respective personality traits may be uniquely rated on a value scale, while statistical information on the number of other subscribers rating that subscriber and the history of ratings may be displayed. Other subscribers may also provide commentary about any of those personal attributes.

An employment subsystem 46 may be provided that allows subscribers to view internships or other jobs opportunities. The process may be automated so that subscribers may utilize an automated selection process that matches values and/or personality and/or skills of individuals and/or institutions/legal entities. Such matches may be based on personality traits, overall impression scores, job or skill type, geography, or other criteria. Used in conjunction with the personal matching subsystem 44 in which subscribers may locate others with similar values and experiences, the employment subsystem 46 may be expanded to provide other scholarship or social opportunities as well.

A commercial subsystem 48 may comprise a “brand advocate” function to allow subscribers to decide which brands or products to advertise on their profile pages and receive payment for conversions. Brands may be also able to solicit and select their brand advocate and offer to pay them to advertise. The commercial subsystem 48 in conjunction with other subsystems may be used to match brand advertisers with individual subscribers.

The scoring subsystem 40 provides an overall impression score, or profile score, at any given time for each subscriber. The algorithm considers the score at the previous observation time and the new raw score for the most recent post, and then is adjusted by several factors, including the amount of activity on the subscriber page, the total traffic on and a diminishing returns factor. The raw score may be a weighted combination of the subscribers scores as a publisher of content (including approval rate and popularity of the content) and as a writer of content for other subscribers (including the productivity of writing, publication rate, and popularity based on the content being read). A subscriber score may also be based on the ratio of publication compared to total submissions, meaning that acceptance of publication and denial of publication both count. There may also be a penalty for inactivity on the subscriber site.

Given the various factors used in the scoring subsystem, the overall impression score 206 is derived. In general, the higher scores are considered better in that the content of the subscriber's profile page is gauged to be of high quality and truthfulness. The impression score 206 may be a self-awareness metric as it evaluates the personal, reliability, trustworthiness, integrity and other factors affecting self-awareness. As such, impression management by a subscriber may be desired.

The process for using the system may include some or all of the steps set forth below:
Subscriber creates an account or registers independently or through invitation. The system then will establish and validate credentials.
Subscribers then interact with other subscribers by writing news (in the form of but not limited to text), receiving news (in the form of but not limited to text), validating information, and grading content. News can be created at the discretion of any user and is sent privately to the recipient's account.
Content may be published at the discretion of the recipient in the form and resemblance of printed daily newspapers, adapted to the web and a worldwide diverse audience;
Recipient may have a predefined timeframe in which to review and approve the content and as a result, the content is either published on the recipient's newspaper or not and the score updated to register the action of the recipient and the writer. Extending beyond the timeframe may result in an automatic denial of publication.
Subscribers may then read newspapers of other subscribers, rate articles on quality, content and other factors and increase the popularity of an article. The scores are updated accordingly.
There may be an article placement algorithm which determines the position that the article should have on the page. Articles may also have an expiration date to keep the content fresh or optionally kept indefinitely. Moreover, subscribers may solicit fresh content from other subscribers. A bidding system to move articles within the profile and landing/home pages may allow users to offer a form of payment to give more relevance to specific articles always after an “equal opportunity” bidding process.
Subscribers may subscribe to newspapers of other subscribers and receive notification when a new article is published. Such a subscription may or may not be based on the approval of the other subscriber.

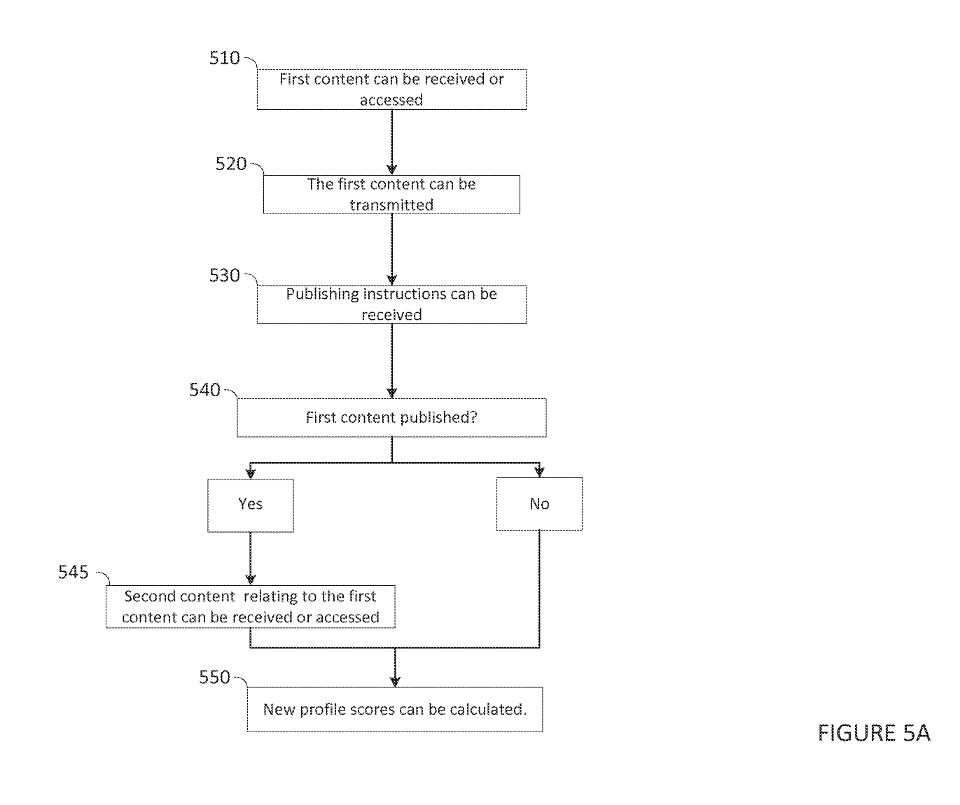

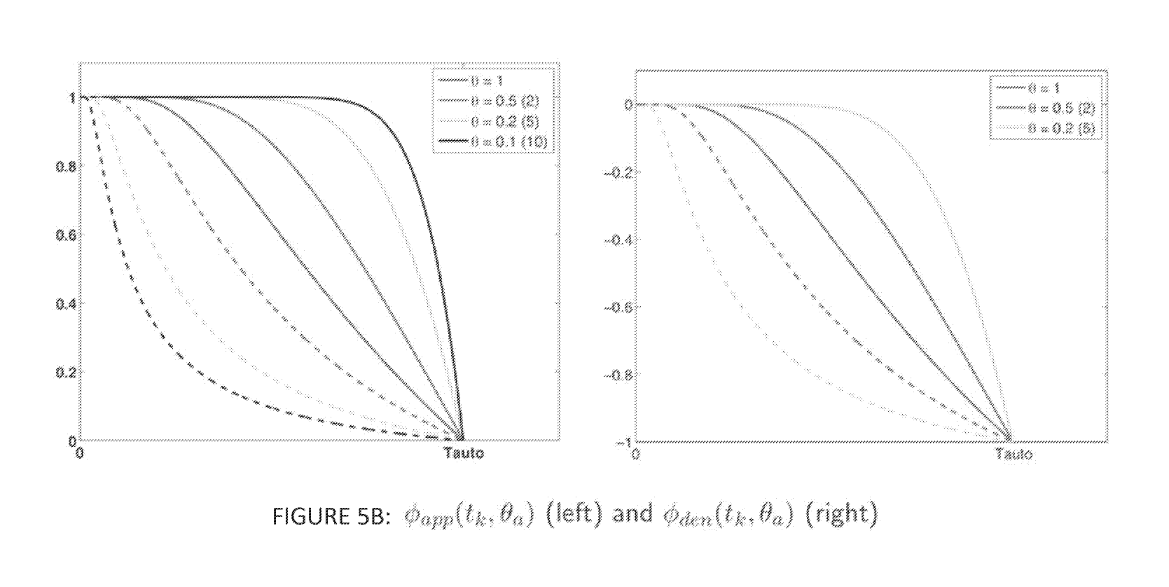

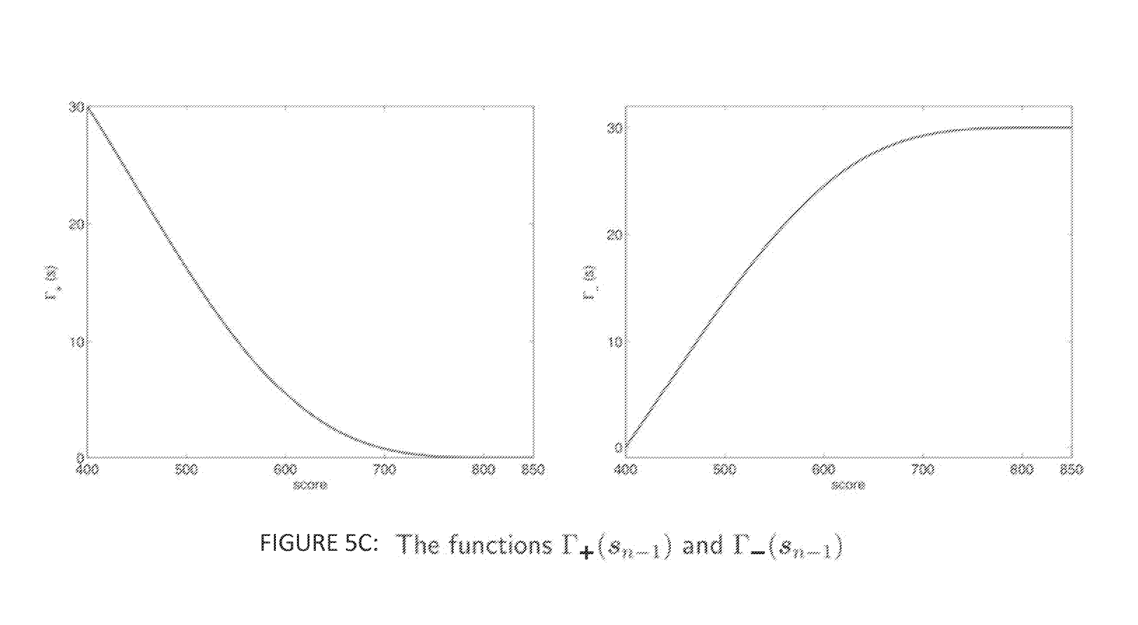

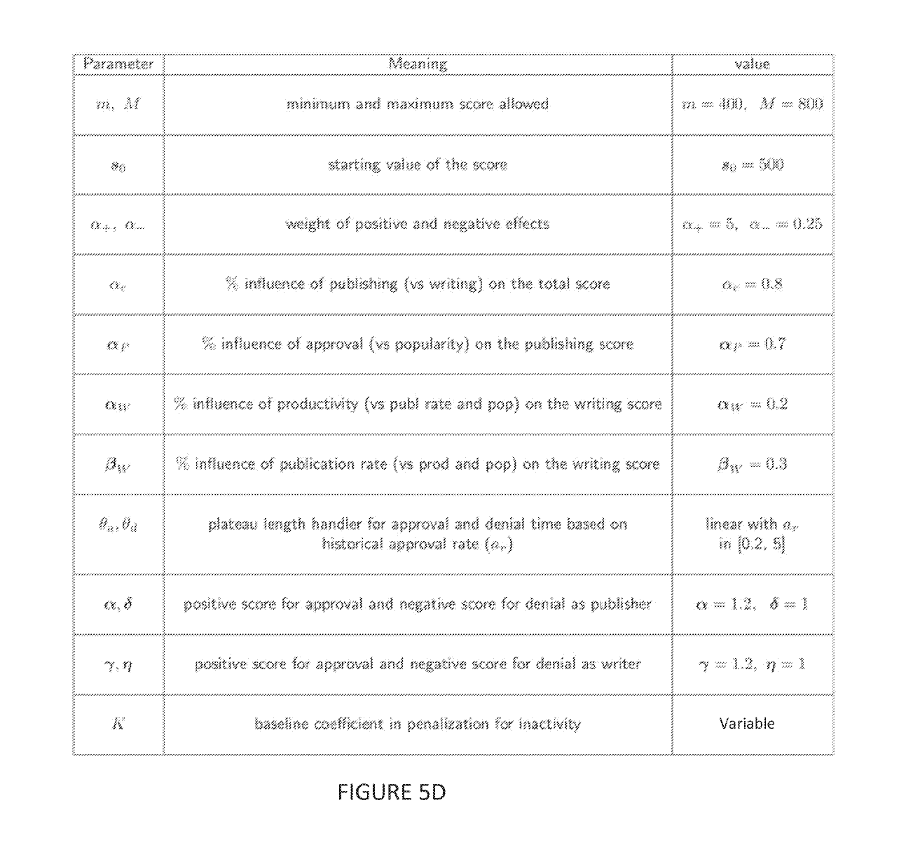

FIG. 5 illustrates an exemplary method according to an aspect of the present disclosure. In an aspect, the method can be implemented via a combination of publishing subsystem 42, content receiving subsystem 38, and scoring subsystem 40; however, other combinations of systems and subsystems can be used to implement the method.

In 510, first content is received or accessed. The first content can be text, images, audio, video, or other types of media. For example, the first content can be an article that a first subscriber on the on-line networking site has created about a second subscriber. The first content can also be an article that the second subscriber creates about himself. The article can relate to an interaction that the first subscriber had with the second subscriber. The article can be a general commentary about the second subscriber. The article can include written text about the second subscriber, an image relating, but not limited to, to the second subscriber, and/or an audio or video recording of the second subscriber. As an example, if a customer of an internet service provider has a problem with his internet not working, he can call a technical support line for assistance. Based on the customer's experience with the technical support representative, the customer can write a review of the representative on the on-line networking site, and the customer can even include an audio recording of the phone call. The first content in 510 can be received or accessed by, for example, a computer or server, such as server 30 on which application 31 resides from FIG. 1. A subscriber can be anyone who has a profile associated with the on-line user network site.

In 520, the first content can be transmitted. The transmission of the first content can occur, for example, via system 10 illustrated in FIG. 1. The first content can be transmitted to a subscriber on the on-line networking site. The author of the content can be designated as anonymous or the computer can identify the author. Such anonymity/identification can be based on instructions from the author or another user/subscriber. The first content can be transmitted by a computer or server, such as server 30 from FIG. 1. For example, a first subscriber can submit content about a second subscriber on the on-line networking site. The computer can then receive or access the content and then transmit the content to the second subscriber's profile via system 10. The transmitted content can be configured for the private viewing of the second subscriber only. As an example, private viewing can allow only the second subscriber to view the transmitted first content. As a further example, until the second subscriber elects to publish the transmitted first content, no other users or subscribers can view the first content.

In 530, publishing instructions can be received or accessed. The publishing instructions can relate to the election to publish the first content. The publishing instructions can include instructions on whether to publish the name of the author of the first content. Publishing can comprise, for example, posting content on a profile page associated with a subscriber. The first content can be made viewable to specific individuals, groups, subscribers, or users, or the first content can be made viewable to anyone. The publishing instructions can be received by, for example, the computer. The publishing instructions can, for example, be sent by the second subscriber relating to a decision whether to publish the first content provided by the first subscriber.

In 540, the first content either is or is not published. Whether or not content is published can depend, for example, on the publishing instructions. If the computer receives instructions to publish the first content, then the computer can publish the first content. On the other hand, if the computer receives instructions not to publish the first content, then the first content can remain unpublished. For example, the computer can receive instructions from a subscriber to publish particular content. The computer can then publish the content on, for example, the subscriber's profile page. The content can then be available for all or select users or subscribers to view. On the other hand, the computer can receive instructions from a subscriber not to publish particular content. The computer can then not publish the content.

An example of steps 510-540 can be as follows. A restaurant patron dines at a local restaurant and is served by a waiter. The patron later submits an article about the waiter. The article includes a written text about the patron's interaction with the waiter, and perhaps a picture of the waiter as well. The computer receives the submitted article and sends it to the waiter's profile. The waiter reads the article and decides to publish it on his profile page on the site. The computer then receives instructions from the waiter to publish the article, and the computer then publishes the article on the waiter's profile page. In the case that the waiter decides not to publish the article, the computer receives instructions not to publish the article and the article is not published.

In 545, a second content can be received or accessed. The second content can be received from a third subscriber or a user of the on-line networking site. The second content can relate to the first content. For example, the second content can be an indication of whether the first content relating to the second subscriber is accurate.

As an example, the computer receives a first content from a first customer of a cable provider relating to an interaction that the first customer had with a technical support representative of the cable provider. The computer transmits the first content to the profile of the technical support representative. The computer then receives instructions from the technical support representative to publish the first content. A second customer has a second interaction with the technical support representative. The second customer views the first content that was published on the technical support representative's profile page. The computer then receives a second content from the second customer indicating that the first content relating to the technical support representative is accurate. In an alternative example, the computer receives a second content from the second customer indicating that the first content relating to the technical support representative is not accurate.

In 550, one or more new profile scores can be calculated. The profile score can be, for example, an impression score, a self-awareness metric, or other metrics related to the profile owner. The new profile score can be calculated for a single subscriber or multiple subscribers. The new profile score can be based at least in part on whether the computer receives instructions from a subscriber to publish content or not, first content that a subscriber submits, articles published on the subscriber's profile, second content received relating to the first content, or other factors. A profile score can be based on a previously existing score on a subscriber's profile combined with a score change from the subscriber's activity on the networking site and any penalty for inactivity, as shown below:

sₙ=sₙ₋₁+cₙ×Φ(eₙ)×ln(1+eₙ)×Γ(sₙ₋₁)−Pen(n)

where
sₙ: calculated profile score
sₙ₋₁: previous profile score
cₙ: score obtained from activity on the site by subscriber
eₙ: active activity count on the profile in the observation window
ln(1+eₙ): the natural logarithm of (1+eₙ)
Φ(eₙ): weight taking traffic on the site into account
Γ(sₙ₋₁): function based on diminishing return
Pen(n): penalty for inactivity

The cₙ score is a weighted combination of a publisher (p(n)) and a writer (w(n)) score that are computed along an observation window of two scoring times (Tₙ=[n−2,n]):

cₙ=α_{c}p(n)+(1−α_{c})(w(n)

The publisher p(n) score depends upon an approval rate and popularity in that

p(n)=αₚapp(n)+(1−αₚ)pop(n)

Where app(n) represents the approval rate and pop(n) represents popularity. α_{c} and αₚ here are weighting coefficients (relative numbers between 0 and 1) that are intended to measure the relative importance of the two components. For example, if α_{c}=0.5 then both the publisher and writer scores contribute equally to the construction of cₙ; if α_{c}>0.5 then the publisher is dominant.

The approval rate can contain a diminishing return expression represented by the following equations:

$${φ}_{app} ( {t}_{k} , {θ}_{a} ) = 1 - exp ( \frac{{t}_{k} - {T}_{auto}}{{θ}_{a} {t}_{k}} )$$

$${φ}_{den} ( {t}_{k} , {θ}_{d} ) = - exp ( \frac{{t}_{k} - {T}_{auto}}{{θ}_{d} {t}_{k}} )$$

where
φₐₚₚ: the diminishing return principle of approving publication
φ_{den}: the diminishing return principle for denying publication:
k=1, . . . , Nₚ: article id number on the profile
tₖ: the decision moment about article with label k
Tₐᵤₜₒ is the auto denial time.
The value θ_{α} is given by:

θₐ=[min(θₐ)−max(θₐ)]aᵣ+maxθₐ

where

$${a}_{r} = \frac{\# articles published}{\# articles received}$$

aᵣ can represent the historical approval rate of the profile owner.

The approval rate can also include a raw score z(n) shown below:

$$z ( n ) = {\sum }_{k received in {T}_{n}} α {φ}_{app} ( {t}_{k} , {θ}_{a} ) + {\sum }_{k denied in {T}_{n}} δ {φ}_{den} ( {t}_{k} , {θ}_{d} ) - {\sum }_{k autodenied in {T}_{n}} δ$$

Where in this case, α is the positive score given for approving publishing an article, and where δ is the absolute value of the negative score given for denying publishing an article. For mathematical reasons, the quantity of δ is a positive number.
FIG. 5B is a set of graphical representations of φₐₚₚ (tₖ,θₐ) and φ_{den}(tₖ,θ_{d}). The raw score z(n) is weighed by the maximum possible positive where all content is approved quickly:

$${\sum }_{k received in {T}_{n}} α$$

when z(n) is positive, and by a maximum possible negative where all articles go to auto denial:

$${\sum }_{k received in {T}_{n}} δ$$

when z(n) is negative. The final result of app(n) can therefore be:

$$app ( n ) = \frac{z ( n )}{\frac{sign ( z ( n ) ) + 1 )}{2} \times {\sum }_{k received in {T}_{n}} α + \frac{1 - sign ( z ( n ) )}{2} \times {\sum }_{k received in {T}_{n}} δ}$$

where sign(x) is the mathematical “sign” function defined as sign(x)=1 if x≧0 and sign(x)=−1 if x<0.

The popularity term pop(n) can represent a compounded effect of the global popularity of the subscriber's profile (variety(n)) and of the various articles present on the profile (success (n)). In the equations below k=1, . . . , Nₚ is the article id number on a profile and r (k, Tₙ) is the number of independent reads of an article with label k during Tₙ.

$$variety ( n ) = \frac{\# ( articles read during {T}_{n} )}{\# ( articles on profile during {T}_{n} )}$$

$$success ( n ) = 1 - \frac{1}{{\sum }_{k available during {T}_{n}} r ( k , {T}_{n} ) + 1}$$

The popularity pop(n) can be given by:

pop(n)=variety(n)×success(n)

The writer score (w(n)) can be a weighted combination of productivity write(n), publication rate pub(n), and popularity read (n). The equation can be given by:

w(n)=a_{W}write(n)+β_{W}pub(n)+(1−α_{W}−β_{W})read(n)

where write(n) can be given by:

$$write ( n ) = \frac{\# ( people suscriber wrote about during {T}_{n} )}{\# ( articles written during {T}_{n} )}$$

pub(n) can be given by:

$$pub ( n ) = \frac{{\sum }_{k published in {T}_{n}} γ - {\sum }_{k denied in {T}_{n}} η}{{\sum }_{k written in {T}_{n}} max ( γ , η )}$$

and read(n) can be given by:

$$read ( n ) = {[ {\sum }_{k available during {T}_{n}} pos ( k , {T}_{n} ) \frac{{N}_{P ( k )} ( {T}_{n} )}{{\sum }_{k available during {T}_{n}} {N}_{P ( k )} ( {T}_{n} )} ]}^{- 1}$$

### Where:

P(k): profile on which the article labeled k is published
Nₚ₍ₖ₎: average total number of articles therein during Tₙ
pos(k, Tₙ): average positioning of article “k” during Tₙ

The activity weight eₙ can represent the activity count on the profile in the observation window, given by:

eₙ=#(articles written)+#(articles accepted/denied)+#(articles read)

The traffic weight Φ(eₙ) can take into account the amount of traffic on the profile owner's page. If the volume traffic on the profile owner's page is low, then the raw score change cₙ can have a large impact on the calculated score change from sₙ₋₁ to sₙ. If the volume traffic is high then the raw score change cₙ can have a small impact on the calculated score change from sₙ₋₁ to sₙ. The weight function can be given by:

$$Φ ( {e}_{n} ) = 1 + 9 \times min [ 1 , exp ( \frac{{e}_{n} - {e}_{threshold}}{{e}_{n} - {e}_{max}} ) ]$$

The function Γ(sₙ₋₁) can be based on the diminishing return, given by:

$$Γ ( {s}_{n - 1} ) = {α}_{+} \frac{sign ( {c}_{n} ) + 1}{2} \times {Γ}_{+} ( {s}_{n - 1} ) + {α}_{-} \frac{sign ( {c}_{n} ) - 1}{2} \times {Γ}_{-} ( {s}_{n - 1} )$$

where

$${Γ}_{+} ( {s}_{n - 1} ) = {[ \frac{{s}_{n - 1} - M}{m - M} ]}^{p ( {s}_{n - 1} )}$$

$${Γ}_{-} ( {s}_{n - 1} ) = {[ \frac{{s}_{n - 1} - M}{m - M} ]}^{q ( {s}_{n - 1} )}$$

and where α₊ and a₊ can be coefficients that allow the ability to differentiate the positive and negative impact. Also, the exponents can be given by:

$$p ( {s}_{n - 1} ) = q ( {s}_{n - 1} ) = \frac{2}{M - m} ( {s}_{n - 1} - m ) + 2$$

and m and Mcan be the maximum and minimum score allowed
FIG. 5C is a set of graphical representations of an example of Γ₊(sₙ₋₁) and Γ₋(sₙ₋₁) where a₋=a₊=30, m=400, and M=800.

The penalization score Pen(n) can take into account any recent lack in activity on the profile. It can also take into account the minimal admissible score value m (to avoid the score from dropping below zero). The penalization score can be given by:

Pen(n)=Ψ(n)χ_{{e}_{ₙ₋₁}₌ₑ_{ₙ₋₂}_{=0}}χ_{{s}_{ₙ₋₁}_{>m}}

where

$${χ}_{\{ {e}_{n - 1} = {e}_{n - 2} = 0 \}} = \{ \begin{matrix}1 & if {e}_{n - 1} = {e}_{n - 2} = 0 \\ 0 & elsewhere\end{matrix} \\ {χ}_{\{ {s}_{n - 1} > m \}} = \{ \begin{matrix}1 & if {s}_{n - 1} > m \\ 0 & elsewhere\end{matrix}$$

are characteristic functions of the sets.
{eₙ₋₁=eₙ₋₂=0} represents lack of activity in the previous two observational periods
sₙ₋₁>m ensures that the score does not fall under the minimal value
   The decay Ψ(n) can be based on the diminishing return:

Ψ(n)=K×Γ₋(sₙ₋₁)

where K is a constant.

FIG. 5D is a summary of parameters used in the equations for calculating profiles scores.

In an aspect of the current disclosure, the method illustrated in FIG. 5 can be performed in a closed setting. Closed setting can mean that content about a subscriber is received from only specific users in a group. A group can be, for example, a research group at a university or the employees at a business. The content received from the closed group can be viewable only by those within the group. In one aspect, the content can be received from any subscriber or user in the group. Additional content can be received from any member of the group relating to the veracity of the first content received. In another aspect, the content can be received from only a specific member of the group, such as the group leader. As an example, profile scores can be calculated based only on the content received from members inside the group. In one aspect, who can view the articles or profile scores can be determined by instructions received from a specific subscriber in the group, such as the group leader. The profiles of the subscribers of the group can have different scores for content received within the group and content received outside the group. In another aspect, the content received from within a group about a first subscriber in the group can be published publicly so that content can be received from all users and subscribers relating to the veracity of the content.

As an example, a business sets up a group on the on-line networking site. This group is limited to the employees of the business. The employees can write articles about each other, but anyone who is not an employee cannot view the articles. Profile scores can be calculated based only on the content submitted and published within the group. This profile score can be seen only by those within the group. The group leader can also control who can view the profile scores within the group. This can allow the group leader to track the progress of the employees. The members of the group have separate scores viewable by all subscribers and users for articles submitted by anyone outside the group.

In another aspect, first content can be received relating to a group. A group can comprise multiple subscribers, such as a research group or business team. The group can have its own profile page. The first content can be transmitted to all or specific the members of the group. Publishing instructions can be received from all or specific members of the group. The publishing instructions can relate to publishing on an individual subscriber's profile page within the group or on the group profile page. Publishing can occur based on the instructions received. Publishing can be made viewable to the public or specified users or subscribers, such as only the members of the group or the group leader.

As an example, a business team is composed of individual subscribers to an on-line networking site. The leader of the team creates a group on the on-line working site in which the members of the team are the subscribers in the group. The group members write articles about the group. The leader sets it so that only members of the group can view or comment on the articles. A profile score is calculated for the group based on the articles. In this way the leader can track the progress of the group. In another example any user or subscriber can submit articles about the group. In both examples, the group can have its own profile score.

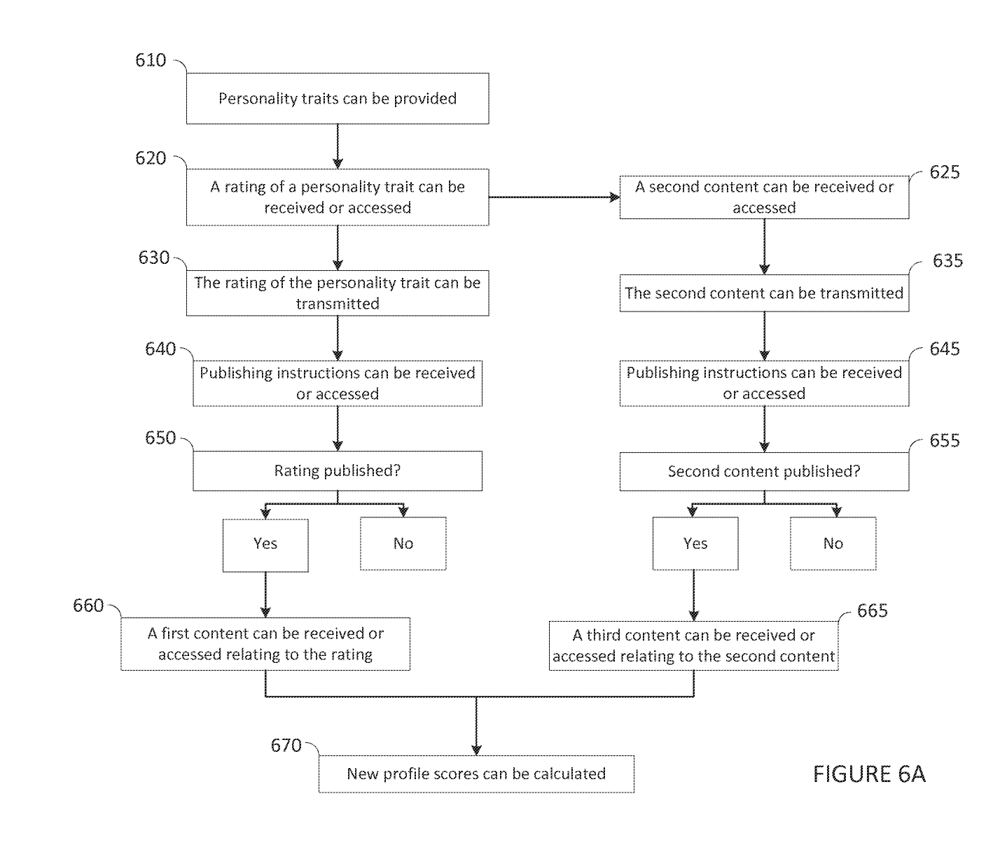

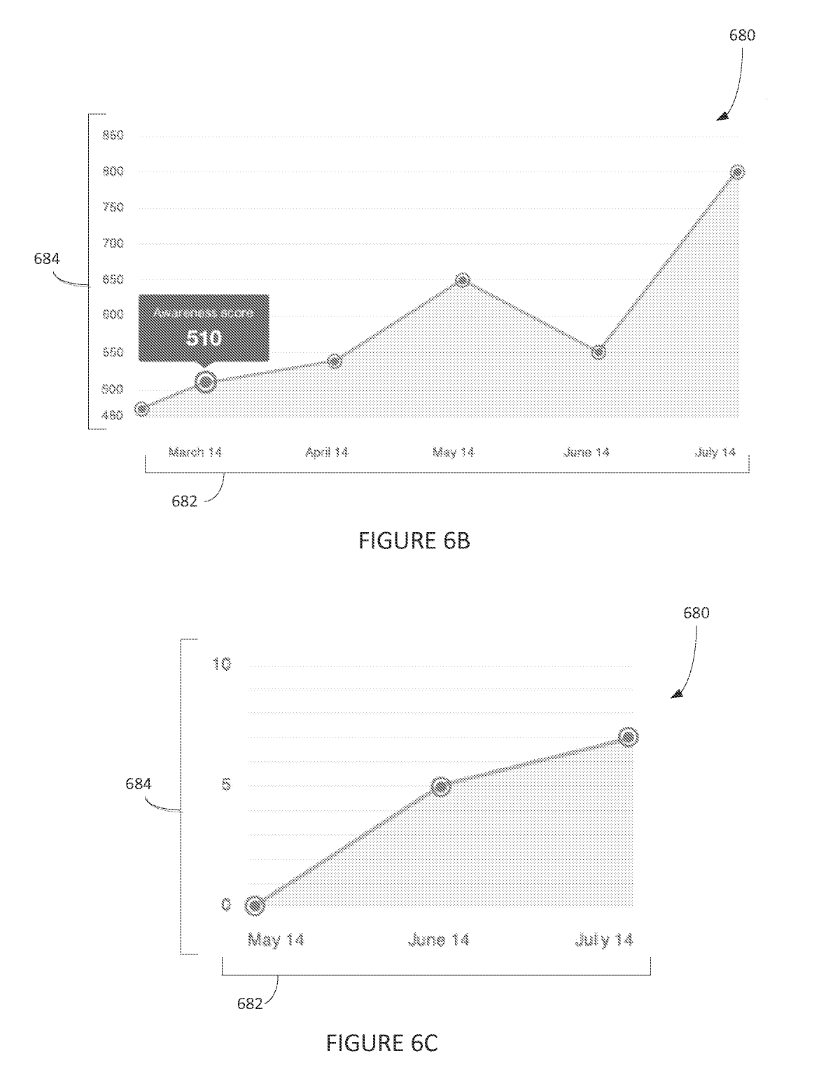

FIG. 6A illustrates an exemplary method according to an aspect of the present disclosure. In an aspect, the method can be implemented via a combination of publishing subsystem 42, content receiving subsystem 38, scoring subsystem 40, and skillset subsystem 43; however, other combinations of systems and subsystems can be used to implement the method.

In 610, any number of personality traits can be provided. The personality traits can be pre-defined by a computer. The personality traits can also be created by a subscriber. In an aspect, the computer can be a computer or server such as server 30 from FIG. 1. The personality traits can relate to any number of type of trait or characteristic and can include, for example, reactivity, resilience, optimism, adaptability, initiative, and collaboration. As an example, the computer can display a default set of personality traits on a subscriber's profile. As another example, the computer can also allow subscribers to choose from a list of personality traits to display on the subscriber's profile. As a further example, the computer can provide a definition of each personality trait.

In 620, a rating of a personality trait can be received or accessed. The rating can be a number rating on a scale. For example, the rating can be a number on a scale from 0 to 10 with 0 being the lowest rating and 10 being the highest. Ratings can also take other forms, such as letters or other symbols. The ratings can be a representation of to what degree a subscriber possesses a certain personality trait. As an example, a first subscriber can have an interaction with a second subscriber, and the first subscriber could feel that the second subscriber merits a 6 out of 10 in one of the personality traits, such as adaptability. The first subscriber can rate the adaptability of the second subscriber on the second subscriber's profile page as a 6 out of 10. The computer can also receive personality trait ratings about a subscriber from that same subscriber. The rating in 620 can be received or accessed by, for example, a computer or server, such as server 30 from FIG. 1.

There can arise an instance where more than one rating is received for a personality trait. This can occur, for example, where more than one subscriber or user rates the same personality trait of a first subscriber. An overall rating of the personality trait associated with the first user can be calculated that takes into account the multiple ratings of the personality trait. The calculation can be an average of all the ratings received. The calculation can include a diminishing return expression that makes older ratings have a lower impact on the overall score. For example, if a first subscriber rates the adaptability of a second subscriber as a 6 out of 10, and a third subscriber rates the adaptability of the second subscriber as an 8 out of 10, then the calculated overall rating of adaptability of the second subscriber can be the average of 8 and 6, which is 7. Or, if the first subscriber rates the adaptability of the second subscriber before the third subscriber, then with a diminishing return expression the overall score of the adaptability of the second subscriber could be greater than 7.

In 630, a rating of a personality trait can be transmitted. The transmission of the rating can occur, for example, via system 10 illustrated in FIG. 1. The rating can be transmitted to a subscriber on the on-line networking site. The computer can keep the author of the rating anonymous or inform the subscriber who the author is based on the author's instructions. The rating can be transmitted by a computer or server, such as server 30 from FIG. 1. For example, a first subscriber can submit a rating about a second subscriber on the on-line networking site. The computer can then receive or access and then transmit the rating to the second subscriber's profile via system 10. The transmitted rating can be for the private viewing of the second subscriber only. As an example, private viewing can allow only the second subscriber to view the transmitted rating. As a further example, until the second subscriber elects to publish the transmitted rating, no other users or subscribers can view the rating.

In 640, publishing instructions can be received or accessed. The publishing instructions can relate to the election to publish the transmitted rating. The publishing instructions can include instructions on whether to publish the name of the author of the rating. Publishing can comprise, for example, posting a rating of a personality trait on a profile page associated with a subscriber. The rating can be made viewable to specific individuals, groups, subscribers, or users, or the rating can be made viewable to anyone. The publishing instructions can be received by the computer. The publishing instructions can, for example, be sent by the second subscriber relating to a decision whether to publish the rating provided by the first subscriber.

In 650, a rating either is or is not published. Whether or not a rating is published can depend, for example, on the publishing instructions. If the computer receives instructions to publish the rating, then the computer can publish the rating. On the other hand, if the computer receives instructions not to publish the rating, then the rating can remain unpublished. For example, the computer can receive instructions from a subscriber to publish a particular rating. The computer can then publish the rating on, for example, the subscriber's profile page. The rating can then be available for all or selected users or subscribers to view. On the other hand, the computer can receive instructions from a subscriber not to publish particular rating. The computer can then not publish the rating.

An example of items 610, 620, 630, 640, and 650 together could be as follows. A first subscriber dines at a restaurant one day where a second subscriber is the first subscriber's waiter. After dining at the restaurant the first subscriber accesses the on-line networking site and accesses the profile page of the second subscriber. The first subscriber rates the optimism of the second subscriber as a 4 out of 10. The computer receives the rating and transmits it to the second subscriber privately so that no other user or subscriber can view the rating. The second subscriber instructs the computer to publish the rating. The computer receives the publishing instructions and then publishes the rating so that all viewers on the on-line networking site can see the rating given by the first subscriber.

In 660, a first content can be received. The first content can relate to a rating of a personality trait. The content can be text, images, audio, video, or other types of media. For example, the content can be an article that a third subscriber or a user on the on-line networking site has created about the rating of a personality trait that the first subscriber gives the second subscriber. The article can include written text about the second subscriber, an image relating to the second subscriber, and/or an audio or video recording of the second subscriber.

As an example, a first restaurant patron who is a subscriber to the on-line networking site dines at a restaurant in which a second subscriber serves as the patron's waiter. After dining the first patron accesses the profile of the waiter on the on-line networking site and rates the optimism of the waiter, a personality trait, as a 4 out of 10. The waiter sends instructions to the computer to publish the rating. The computer receives the instructions and publishes the rating. Six months later a second patron, a third subscriber, dines at the same restaurant and has the same waiter. After dining at the restaurant the second patron accesses the on-line networking site and accesses the profile page of the waiter. The third subscriber sees the 4 out of 10 rating for optimism that was published. The second patron disagrees with the rating, feeling that the rating should be an 8 out of 10. The second patron writes an article about the 4 out of 10 rating indicating that it is not accurate.

The second patron can also submit his own rating of the waiter's optimism. The computer receives the rating and transmits it to the waiter privately so that no other user or subscriber can view the rating. The waiter instructs the computer to publish the rating. The computer publishes the rating and all or select viewers on the on-line networking site can see the rating given by the second patron. The computer also calculates a new overall rating for the optimism personality trait on the second subscriber's profile. Because the first rating was 6 months ago, the diminishing return expression makes the first rating have a lower impact on the overall score of the personality trait. For example, the computer can publish an optimism score of 7 on the second subscriber's profile.

In 625 of FIG. 6A, a second content can be received or accessed. The content can be text, images, audio, video, or other types of media. For example, the second content can be an article that a first subscriber on the on-line networking site has created about a second subscriber. The article can be about a rating of a personality trait that the first subscriber gave the second subscriber. The article can include written text about the second subscriber, an image relating to the second subscriber, and/or an audio or video recording of the second subscriber. The second content in 625 can be received or accessed by, for example, a computer or server, such as server 30 on which application 31 resides from FIG. 1. A subscriber can be anyone who has a profile associated with the on-line user network site.

As an example, if a customer of an internet service provider has a problem with his internet not working, he can call a technical support line for assistance. Based on the customer's experience with the technical support representative, the customer can write a review of the representative on the on-line networking site, and he can even include an audio recording of the phone call. The customer can also rate a personality trait of the technical support representative. The customer can further write an article about the rating of a personality trait he gave the technical support representative. The computer can receive the article and publish it on the technical support representative's profile along with the rating.

In 635, the second content can be transmitted. The transmission of the second content can occur, for example, via system 10 illustrated in FIG. 1. The second content can be transmitted to a subscriber on the on-line networking site. The computer can keep the author of the second content anonymous or inform the subscriber who the author is based on the author's instructions. The second content can be transmitted by a computer or server, such as server 30 from FIG. 1. For example, a first subscriber can submit content about a second subscriber on the on-line networking site. The second content can relate to a rating of a personality trait that the first subscriber submits about the second subscriber. The computer can then receive or access and then transmit the second content to the second subscriber's profile via system 10. The second content can be for the private viewing of the second subscriber only. As an example, private viewing can allow only the second subscriber to view the second content. As a further example, until the second subscriber elects to publish the second content, no other users or subscribers can view the second content.

In 645, publishing instructions can be received or accessed. The publishing instructions can relate to the election to publish the second content. The publishing instructions can include instructions on whether to publish the name of the author of the second content. Publishing can comprise, for example, posting content on a profile page associated with a subscriber. The second content can be made viewable to specific individuals, groups, subscribers, or users, or the second content can be made viewable to anyone. The publishing instructions can be received by, for example, the computer. The publishing instructions can, for example, be sent by the second subscriber relating to a decision whether to publish the second content provided by the first subscriber.

In 655, the second content either is or is not published. Whether or not the second content is published can depend, for example, on the publishing instructions. If the computer receives instructions to publish the second content, then the computer can publish the second content. On the other hand, if the computer receives instructions not to publish the second content, then the second content can remain unpublished. For example, the computer can receive instructions from a subscriber to publish particular content. The computer can then publish the content on, for example, the subscriber's profile page. The content can then be available for all or select users or subscribers to view. On the other hand, the computer can receive instructions from a subscriber not to publish particular content. The computer can then not publish the content.

In 665, a third content can be received or accessed. The third content can be received from a third subscriber or a user of the on-line networking site. The third content can relate to the second content. For example, the third content can be an indication of whether the second content relating to the second subscriber is accurate.

An example of 610, 620, 625, 635, 645, 655, and 665 together can be as follows. A first restaurant patron dines at a local restaurant and is served by a waiter. The first patron later submits a rating of the waiter's optimism on the on-line networking site. The first patron then submits an article about the rating that the first patron gave the waiter. The computer receives the article and transmits it to the waiter's profile on the on-line networking site so that only the waiter can see the article. The waiter sends instructions to the computer to publish the article. The computer publishes the article on the waiter's profile page. A few weeks later a second restaurant patron dines at the same restaurant and is served by the same waiter. The second patron later accesses the profile page of the waiter on the on-line networking site and sees the article the first patron submitted about the optimism rating he gave the waiter. The second patron submits a second article indicating that he agrees with the first article submitted by the first patron. If the second patron were to disagree, then he could submit an article indicating so.

In 670 new profile scores can be calculated. A new profile score can be calculated for a single subscriber or multiple subscribers. The new profile score can be based at least in part on whether the computer receives instructions from a subscriber to publish content or not, content that a subscriber submits, articles published on the subscriber's profile, whether other subscribers or users agree with the published content, ratings received of personality traits, ratings given of personality traits, and the like. The new profile score can be based on a previously existing score on a subscriber's profile combined with a score change from the subscriber's activity on the networking site and any penalty for inactivity. The new profile score can be, for example, an impression score, a self-awareness metric, a personality trait rating, or other metrics related to the profile owner.

In an aspect of the current disclosure, the method illustrated in FIG. 6 can be performed in a closed setting. Closed setting can mean that content about a subscriber is received from only specific users in a group. A group can be, for example, a research group at a university or the employees at a business. The content received from the closed group can be viewable only by those within the group. In one aspect, the content can be received from any subscriber or user in the group. Additional content can be received from any member of the group relating to the veracity of the first content received. In another aspect, the content can be received from only a specific member of the group, such as the group leader. Profile scores and personality trait scores can be calculated based only on the content received from members inside the group. In one aspect, who can view the articles or profile scores can be determined by instructions received from a specific subscriber in the group, such as the group leader. The profiles of the subscribers of the group can have different scores for content received within the group and content received outside the group. In another aspect, the content received from within a group about a first subscriber in the group can be published publicly so that content can be received from all users and subscribers relating to the veracity of the content.

As an example, a research group leader of a university sets up a group on the on-line networking site where the subscribers in the group are the members of his research group. The members can write articles about each other, but anyone who is not a member of the research group cannot view the articles. Profile scores and personality trait scores can be calculated based only on the content submitted and published within the group. This profile score can be seen only by those within the group. The group leader can also control who can view the profile scores within the group. This can allow the group leader to track the progress of the research group members. The members of the group have separate scores viewable by all subscribers and users for articles submitted by anyone outside the group.

In another aspect, first content or personality trait ratings can be received relating to a group. A group can be multiple subscribers, such as a research group or business team. The group can have its own profile page. The first content can be transmitted to all or specific the members of the group. Publishing instructions can be received from all or specific members of the group. The publishing instructions can relate to publishing on an individual subscriber's profile page within the group or on the group profile page. Publishing can occur based on the instructions received. Publishing can be made viewable to the public or specified users or subscribers, such as only the members of the group or the group leader.

As an example, a business team is composed of individual subscribers to an on-line networking site. The leader of the team creates a group on the on-line working site in which the members of the team are the subscribers in the group. The group members write articles about the group or rate personality traits of the group. The leader sets it so that only members of the group can view or comment on the articles. A profile score is calculated for the group based on the articles. In another example any user or subscriber can submit articles about the group. In both examples, the group can have its own profile and personality trait scores. In this way the group leader or others can track the progress of the group.

In another aspect of the present disclosure, the first content in 660 can be feedback content. The feedback content can be suggestions from a first subscriber on how a second subscriber can improve or develop a personality trait. The feedback content can be text, images, audio, video, or other types of media. The feedback content can be excluded from any calculations used in profile or personality trait scoring. As an example, a first subscriber has a calculated personality trait rating of 3 out of 10 for adaptability. A second subscriber sees the ratings and, through the on-line networking site, gives the first subscriber suggestions and techniques on how to improve adaptability.

FIGS. 6B and 6C illustrate exemplary visual representations of an aspect of the invention. In an aspect, a score associated with the profile of a subscriber can be displayed, by the computer, in a development chart 680. Development chart 680 can display the changes in a profile score over a specified time 682. The specified time 682 can be adjustable. For example, the compute can display the score over a few weeks, a few months, a few years, or between two selected dates, all depending on input from the subscriber. The computer can display a score range 684 in development chart 680. Score range 684 can be predetermined by the computer. Score range 684 can also be selected or adjusted by the computer according to input from the subscriber. One axis on development chart 680 can be represented by specified time 682 and the other can be represented by score range 684. FIG. 6B can represent the development chart 680 and a self-awareness score. FIG. 6C can represent the development chart 680 of a personality trait score.

In an aspect, the computer can also display the average profile scores of a group of subscribers over time in development chart 680. The group of subscribers can be, for example, a business team, a project group in a class, a university research group, or other groups. The profile scores can be a self-awareness score, impression score, personality trait score, or other scores. In as aspect of the present disclosure, the computer can display the development chart 680 of the average scores of the group or the individuals. The computer can also display development chart 680 where only the scores given by select subscribers are used. Select subscribers can be the members of the defined group. Select subscribers can also be just one user, such as a group leader. As an example, a research advisor for a university has a research team. Each member of the team has a profile on the on-line networking site. The research advisor organizes the profiles of the team members into a group on the on-line networking site. The research advisor rates the personality traits of the group members. The research advisor then pulls up development charts of the group averages of each rated personality trait and their respective scores over time. The research advisor uses this to track the progress of the group members. In another example, the ratings can be given by all the members of the group instead of just the research advisor.

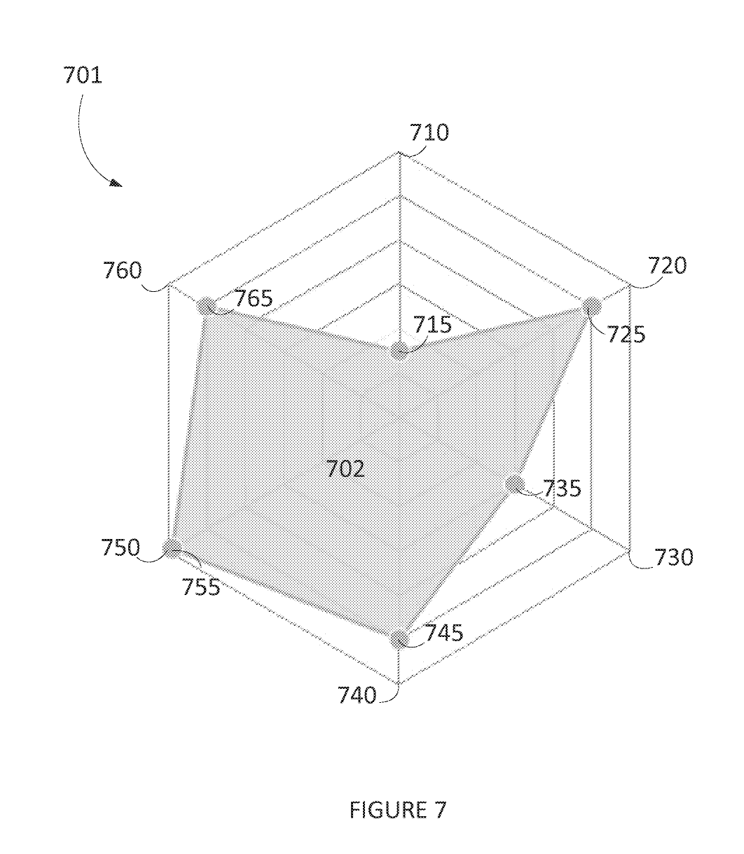

FIG. 7 illustrates an exemplary visual representation of ratings of personality traits of a subscriber's profile. The visual representation can be called a personality radar chart 701. Personality radar chart 701 can be a visual representation of a subscriber's personality profile. A subscriber's personality profile can be the combination of a subscriber's personality traits and their corresponding ratings received. Corners 710, 720, 730, 740, 750, and 760 can each represent a different personality trait of the subscriber. Personality radar chart 701 shows six different personality traits, but it can be appreciated that of any number of personality traits can be displayed in personality radar chart 701. Personality radar chart 701 can display a pre-determined set of default personality traits to display. Personality radar chart 701 can also be customized to display only personality traits selected by a subscriber or user. Each point 715, 725, 735, 745, 755, and 765 can represent a rating of a personality trait. The ratings in FIG. 7 can be the ratings calculated using the method described in FIG. 6. The ratings in FIG. 7 can be positioned on personality radar chart 701 in line with their corresponding personality traits. For example, rating 715 can represent the rating of personality traits of the subscriber. The ratings on personality radar chart 701 can be connected by lines so as to create closed region 702. Closed region 702 can be shaded so as to provide an easy-to-read chart.

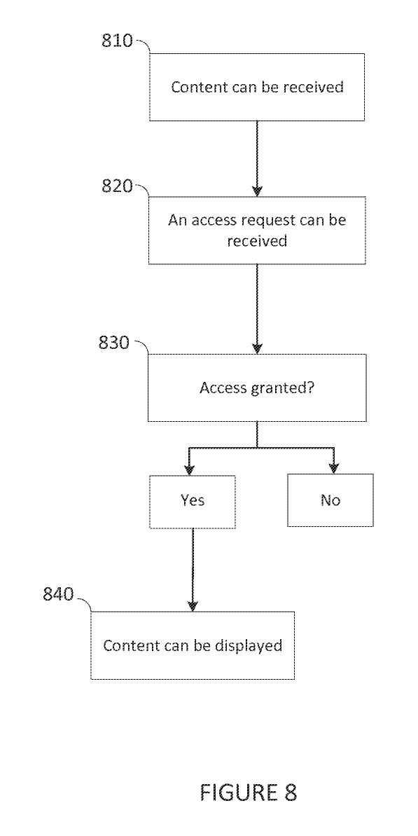

FIG. 8 illustrates an exemplary method according to an aspect of the present disclosure. In an aspect, the method can be implemented via a combination of content receiving subsystem 38, scoring subsystem 40, and employment subsystem 46; however, other combinations of systems and subsystems can be used to implement the method.

In 810, content can be received or accessed. The content can be received from a first subscriber having a first on-line profile associated with an open, on-line user network site. The content can be information relating to characteristics of the first subscriber. For example, the first subscriber could be a business and the content could be general information about the business. The content can be in the form of text, images, audio, video, or other types of media. The content can also be information related to personality traits. The content can include ratings of personality traits. For example, the content can be a personality radar chart 701 or other information relating to an ideal job candidate for a job opening. The content in 810 can be received or accessed by, for example, a computer or server, such as server 30 from FIG. 1.

As an example, a business creates a profile page on an on-line networking site. The business submits content to the server that contains general information about the business. The business also submits content indicates a job opening at the business. The business further submits content relating to the personality traits and scores that the ideal candidate for the job openings could have.

In 820 an access request can be received. The access request can be received from a second subscriber. The access request can relate to an on-line profile of a subscriber. For example, the access request can be or relate to an access of general information on a business's profile page. The access request could also be a request to access information regarding a job posting on the business's profile page. The access request could further be a request to view the personality traits and ratings of an ideal candidate for the job opening. The access request could be a request to access or view any type of information associated with a subscriber's profile. The access request can be received by the computer such as server 30 from FIG. 1.

In 830, access can be granted or denied. The granting or denying of access can be by the computer. The computer can determine whether access should be granted or denied depending on various factors. The factors can be selected by the owner of the profile. For example, one factor can be minimum qualifications. The minimum qualifications can comprise a personality profile containing personality traits and the minimum ratings required for those traits. They can also comprise a minimum impression score or a minimum self-awareness score. There can also be skills or experience requirements.

In 840, the content can be displayed. The content can be information relating to the first subscriber, the second subscriber or both. The content can be, for example, articles written about or posted by the first subscriber, general information about the first subscriber, personality traits and ratings, personality radar charts, or any other content the first subscriber provides. In one aspect the content displayed could be a combination of content relating to the first subscriber as well as content relating to the second subscriber. For example, the content can be the personality radar chart 701 of the first subscriber overlaid with the personality radar chart 701 of the second subscriber.

As an example, a business has a profile page on an on-line networking site. The business's profile page contains general information about the business as well as information relating to job openings. The business submits minimum requirements for access to content on the business's profile, including a personality profile for those traits and ratings that a job candidate must have to apply. The minimum requirements allow all users to view general information about the business, but only subscribers whose personality profiles meet or exceed the personality profile submitted by the business. A job candidate first requests access to view the business's profile page. Because the subscriber is also a user, the candidate is granted access to the business's profile page where the candidate can view only general information about the business. The candidate sees information about a job opening a requests access to view information relating to the job opening. In one scenario, the business allows all subscribers to view information about the job opening. The job candidate requests access to view information relating to the job opening, which is granted because the job candidate is a subscriber. The job opening page can display the personality radar chart of the ideal candidate and the personality profile of the job candidate overlaying each other. The job candidate can then request access to apply for the job, which will be granted only if the job candidate meets minimum requirements provided by the business. In another scenario, the business provides minimum requirements to even view the job opening page. A job candidate can then only view the job opening information if he meets the minimum requirements. If access is granted, the candidate then requests access to apply for the job, which will be granted. In a third scenario, the job candidate can only see that the job opening exists if the candidate already meets the minimum requirements.

In another aspect of the present disclosure, a business can have a profile page on an on-line networking site. The business's profile page can contain general information about the business as well as information relating to job openings and information about the business's culture. The business can permit access to all users and subscribers to view the business's profile page as well as job openings. The business can also permit all subscribers to apply for the job openings. The business can then view the personality radar charts, impression scores, self-awareness metrics, and any other personality metrics of each job applicant to determine whether each applicant would be a good fit for the business's culture or a good fit for a particular job opening.

In another aspect of the present disclosure, the computer can allow business subscribers to request access to the profiles of job candidates. For example, the business subscriber can submit minimum qualifications for a job candidate to the computer. The business subscriber can request access to all subscribers whose personality profile meets the minimum qualifications. The subscribers can instruct the computer whether or not to allow business's access to view their profile. The subscriber can, for example, provide instructions to the computer as to which business or types of businesses, if any, can be granted access to the subscriber's profile. The business will be granted access to all subscriber profiles who have granted access and who meet the minimum qualifications. The business can also request access to contact the subscriber about, for example, to a job opening. The subscriber can grant or allow access to business to contact the subscriber. The subscriber can, for example, provide predetermined criteria for whether a business subscriber can contact the subscriber. The criteria can be minimum requirements for the job opening, such as pay, location, work hours etc.

In another aspect of the invention, the computer can provide a list of job postings that a subscriber can apply for. The list can be based on job openings in which the subscriber's personality profile or other scores match or exceed the minimum requirements for the job posting. The computer can also suggest a career path for the subscriber based on the personality profile and other metrics of the subscriber.

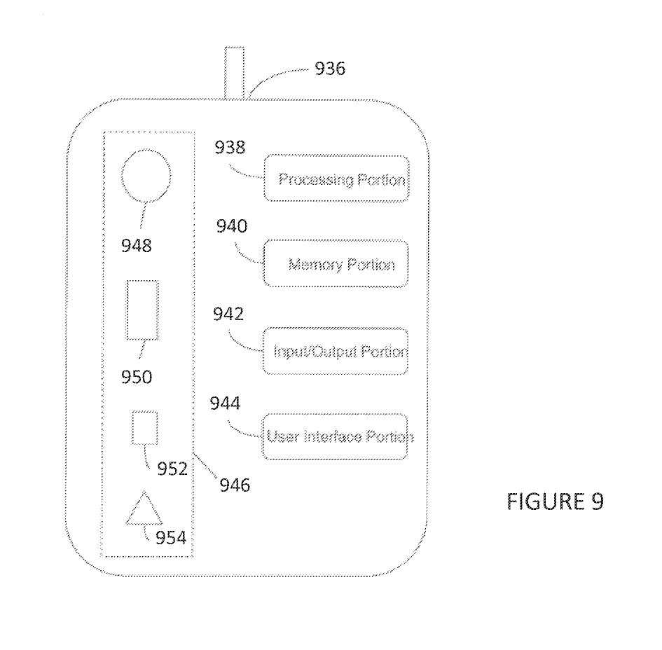

FIG. 9 is a block diagram of an example device 936 that may, for example be a smartphone or other mobile device and which is configurable to access the application 31. The features of the device 936 may be configured to provide the functionality described above or additional functionality. The device 936 can include any appropriate device, mechanism, software, and/or hardware for accessing the application 31 as described herein. As described herein, the device 936 comprises hardware, or a combination of hardware and software. And, each portion of the device 936 comprises hardware, or a combination of hardware and software. In an example configuration, the device 936 can comprise a processing portion 938, a memory portion 940, an input/output portion 942, a user interface (UI) portion 944, and a sensor portion 946 comprising at least one of a video camera portion 948, a force/wave sensor 950, a microphone 952, a moisture sensor 954, or a combination thereof. The force/wave sensor comprises at least one of a motion detector, an accelerometer, an acoustic sensor, a tilt sensor, a pressure sensor, a temperature sensor, or the like. The motion detector is configured to detect motion occurring outside of the communications device, for example via disturbance of a standing wave, via electromagnetic and/or acoustic energy, or the like. The accelerator is capable of sensing acceleration, motion, and/or movement of the communications device. The acoustic sensor is capable of sensing acoustic energy, such as a noise, voice, etc., for example. The tilt sensor is capable of detecting a tilt of the communications device. The pressure sensor is capable of sensing pressure against the communications device, such as from a shock wave caused by broken glass or the like. The temperature sensor is capable of sensing a measuring temperature, such as inside of the vehicle, room, building, or the like. The moisture sensor 954 is capable of detecting moisture, such as detecting if the device 936 is submerged in a liquid. The processing portion 938, memory portion 940, input/output portion 942, user interface (UI) portion 944, video camera portion 948, force/wave sensor 950, and microphone 952 are coupled together to allow communications there between (coupling not shown in FIG. 9).

In various embodiments, the input/output portion 942 comprises a receiver of the device 936, a transmitter of the device 936, or a combination thereof. The input/output portion 942 is capable of receiving and/or providing information pertaining to the application 31 as described herein or other communications with other devices and device types. For example, the input/output portion 942 can include a wireless communications (e.g., 2.5G/3G/4G) SIM card. The input/output portion 942 is capable of receiving and/or sending text information, video information, audio information, control information, image information, data, an indication to initiate a connection, an indication to initiate a transmission, start time information, end time information, interval time information, interval length information, random number value information, connect time information, transmit time information, parsing information, authentication information, or any combination thereof. In an example configuration, the input\output portion 942 comprises a GPS receiver. In an example configuration, the device 936 can determine its own geographical location through any type of location determination system including, for example, the Global Positioning System (GPS), assisted GPS (A-GPS), time difference of arrival calculations, configured constant location (in the case of non-moving devices), any combination thereof, or any other appropriate means. In various configurations, the input/output portion 942 can receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof. In an example configuration, the input/output portion comprises a WIFI finder, a two way GPS chipset or equivalent, or the like.

The processing portion 938 is capable of processing inputs and outputs of the application 31 as well as composing and preparing content as described herein. The processing portion 938, in conjunction with any other portion of the device 936, enables the device 936 to covert speech to text or convert text to speech for uploads/downloads to the application 31.

In a basic configuration, the device 936 can include at least one memory portion 940. The memory portion 940 can store any information utilized in conjunction with voice mail as described herein. Depending upon the exact configuration and type of processor, the memory portion 940 can be volatile (such as some types of RAM), non-volatile (such as ROM, flash memory, etc.). The device 936 can include additional storage (e.g., removable storage and/or non-removable storage) including, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or the like. In an example configuration, the memory portion 940, or a portion of the memory portion 940 is hardened such that information stored therein can be recovered if the device 936 is exposed to extreme heat, extreme vibration, extreme moisture, corrosive chemicals or gas, or the like. In an example configuration, the information stored in the hardened portion of the memory portion 940 is encrypted, or otherwise rendered unintelligible without use of an appropriate cryptographic key, password, biometric (voiceprint, fingerprint, retinal image, facial image, or the like). Wherein, use of the appropriate cryptographic key, password, biometric will render the information stored in the hardened portion of the memory portion 940 intelligible.

The device 936 also can contain a UI portion 944 allowing a user to communicate with the device 936. The UI portion 944 is capable of rendering any information utilized in conjunction the application 31 as described herein. For example, the UI portion 944 can provide means for entering text (including numbers), entering a phone number, rendering text, rendering images, rendering multimedia, rendering sound, rendering video, receiving sound, or the like, as described herein. The UI portion 944 can provide the ability to control the device 936, via, for example, buttons, soft keys, voice actuated controls, a touch screen, movement of the device 936, visual cues (e.g., moving a hand in front of a camera on the mobile device 936), or the like. The UI portion 944 can provide visual information (e.g., via a display), audio information (e.g., via speaker), mechanically (e.g., via a vibrating mechanism), or a combination thereof. In various configurations, the UI portion 944 can comprise a display, a touch screen, a keyboard, a speaker, or any combination thereof. The UI portion 944 can comprise means for inputting biometric information, such as, for example, fingerprint information, retinal information, voice information, and/or facial characteristic information. The UI portion 944 can be utilized to enter an indication of the designated destination (e.g., the phone number, IP address, or the like).

In an example embodiment, the sensor portion 946 of the device 936 comprises the video camera portion 948, the force/wave sensor 950, and the microphone 952. The video camera portion 948 comprises a camera (or cameras) and associated equipment capable of capturing still images and/or video and to provide the captured still images and/or video to other portions of the device 936. In an example embodiment, the force/wave sensor 950 comprises an accelerometer, a tilt sensor, an acoustic sensor capable of sensing acoustic energy, an optical sensor (e.g., infrared), or any combination thereof.

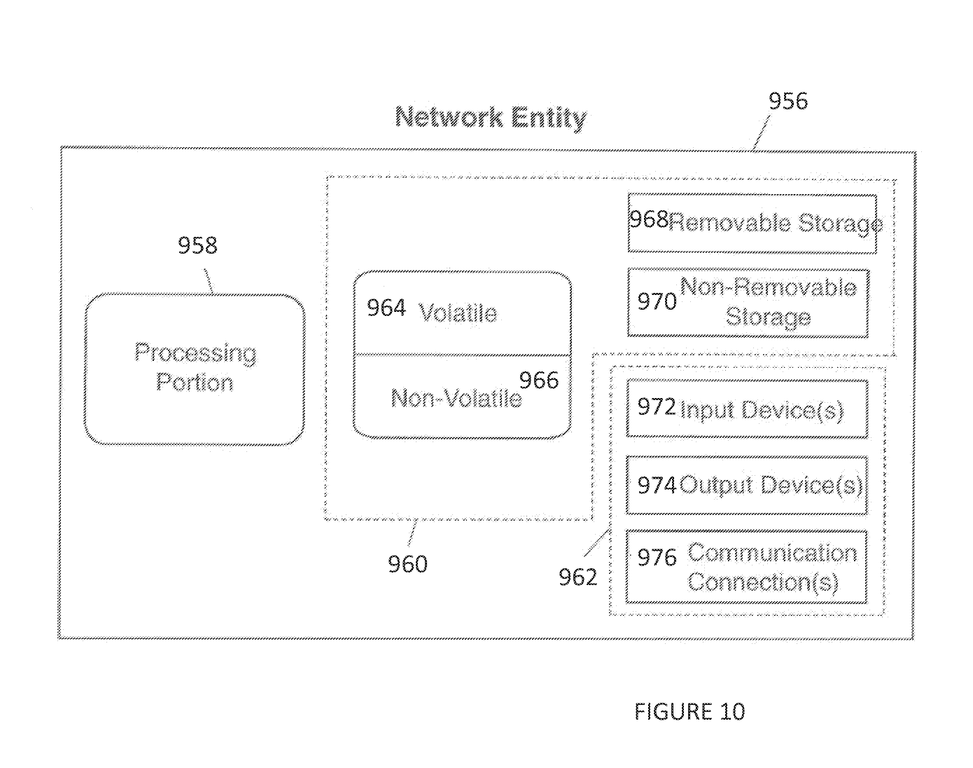

FIG. 10 is a block diagram of an example network entity 956 such as a smart phone configurable to facilitate an application system as described herein. In an example embodiment, the network entity 956 comprises a network entity comprising hardware, or a combination of hardware and software. And, each portion of the network entity 956 comprises hardware, or a combination of hardware and software. When used in conjunction with a network, the functionality needed to facilitate processing of the application 31 may reside in any one or combination of network entities. The network entity 956 represents any appropriate network entity, apparatus, or combination of network entities or apparatuses, such as a processor, a server, a gateway, etc., or any combination thereof. It is emphasized that the block diagram depicted in FIG. 10 is exemplary and not intended to imply a specific implementation or configuration. Thus, the network entity 956 can be implemented in a single processor or multiple processors (e.g., single server or multiple servers, single gateway or multiple gateways, etc.). Multiple network entities can be distributed or centrally located. Multiple network entities can communicate wirelessly, via hard wire, or a combination thereof.

In an example configuration, the network entity 956 comprises a processing portion 958, a memory portion 960, and an input/output portion 962. The processing portion 958, memory portion 960, and input/output portion 962 are coupled together (coupling not shown in FIG. 14) to allow communications therebetween. The input/output portion 962 is capable of receiving and/or providing information from/to a device (e.g. device 936) and/or other network entity configured to be utilized in conjunction with visual voice mail services. For example, the input/output portion 962 is capable of, in conjunction with any other portion of the network entity 956 as needed, receiving and/or sending text information, video information, audio information, control information, image information, data, or any information relating to visual voice mail, or any combination thereof.

The processing portion 958 is capable of performing functions associated with distributing connectivity and/or transmission time, as described herein. For example, the processing portion 958 is capable of, in conjunction with any other portion of the network entity 956 as needed, executing an application for processing the functionality described above, via the user interface portion 944, processing text messages received via the input/output portion 942, processing voice messages received via the input/output portion 942, or the like, or any combination thereof.

The memory portion 960 can store any information utilized in conjunction with the application 31 as described herein. For example, the memory portion 960 is capable of storing information pertaining to all content, which may include other parameters such as an upload or start time, an end time, an interval time, a random number value, a connect time, a transmission time, parsing information, authenticating information, hashing information, encrypting information, a location of a device, a predetermined text/voice message, a text/voice message, a predetermined audio/text message, an audio/text message, subscriber profile information, subscriber identification information, phone numbers, an identification code of the communications device, video information, audio information, control information, information indicative sensor data (e.g., raw individual sensor information, combination of sensor information, processed sensor information, etc.), or a combination thereof. Depending upon the exact configuration and type of network entity 956, the memory portion 960 can include a computer storage medium, or media, that is volatile 964 (such as dynamic RAM), non-volatile 966 (such as ROM), or a combination thereof. The network entity 956 can include additional storage, in the form of computer storage media (e.g., removable storage 968 and/or non-removable storage 970) including, RAM, ROM, EEPROM, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory. As described herein, a computer storage medium is an article of manufacture.

The network entity 956 also can contain communications connection(s) 976 that allow the network entity 956 to communicate with other devices, network entities, or the like. A communications connection(s) can comprise communication media. Communication media can be used to communicate computer readable instructions, data structures, program modules, or other data. Communication media can include an appropriate transport mechanism or information delivery media that can be used to transport a modulated data signal such as a carrier wave.

The network entity 956 also can include input device(s) 972 such as keyboard, mouse, pen, voice input device, touch input device, an optical input device, etc. Output device(s) 974 such as a display, speakers, printer, mechanical vibrators, etc. also can be included.

The communications device (e.g., device 936) and the network entity (network entity 956) can be part of and/or in communication with various wireless communications networks. Some of which are described below.

The benefits of such an application 31 in accordance with the disclosure are many and vary from application to application. Such benefits include, but are not limited to building self-awareness through honest feedback, rewarding personality and popularity that may not be reflected in other objective measurements, creating a culture of on-line etiquette in accessing professional opportunities and trust groups, creating honest competition for jobs on a fair and equal opportunity platform mitigating risk companies face when recruiting and hiring, reducing corporate turnover cost, and increasing job satisfaction.

With respect to the various embodiments of the various figures, it is to be understood that other similar embodiments may be used or modifications and additions can be made to the described embodiments. This written description uses such examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Therefore, apparatuses, systems and methods for turbine clearance flow reduction should not be limited to any single embodiment, but rather should be construed in breadth and scope in accordance with the appended claims.

1. A method comprising:
receiving, by a computer, first content submitted by a first subscriber having a first on-line profile associated with an open, on-line user network site, wherein the first content relates to a second subscriber having a second on-line profile associated with the open, on-line user network site;
transmitting, by the computer, the first content to the second subscriber;
receiving, by the computer, a publication instruction from the second subscriber relating to a decision whether to publish the first content via the second on-line profile; and
calculating, by the computer, a score for the second on-line profile based at least in part on the publication instruction received from the second subscriber.

2. The method of claim 1, wherein the first content relates to an interaction between the first subscriber and the second subscriber.

3. The method of claim 1, wherein the first content relates to a personality trait of the second subscriber and the score for the second on-line profile relates to the personality trait.

4. The method of claim 1, wherein transmitting the first content to the second subscriber facilitates a private viewing of the first content by the second subscriber.

5. The method of claim 1, wherein the score comprises one or more of a self-awareness metric, an impression score, integrity metric, transparency metric, trust metrics, and reliability metric.

6. The method of claim 1, further comprising calculating, by the computer, a score for the first on-line profile based at least in part on the submission of the first content.

7. The method of claim 1, further comprising publishing, via the open, on-line user network site, the calculated score for the second on-line profile.

8. The method of claim 1, further comprising:
publishing, by the computer, the first content via the second on-line profile based on the publication instruction;
receiving, by the computer, second content submitted by a third subscriber having a third on-line profile associated with an open, on-line user network site, the second content relating to the published first content;
updating, by the computer, the score for the second on-line profile based at least in part on the second content.

9. The method of claim 8, further comprising updating, by the computer, the score for the first on-line profile based at least in part on the second content.

10. The method of claim 8, further comprising calculating, by the computer, a score for the third on-line profile based at least in part on the submission of the second content.

11. The method of claim 8, wherein the second content relates to an accuracy of the first content.

12. A system for scoring one or more on-line profiles of subscribers of an open, on-line user network site, the system comprising:
a subsystem for receiving and reviewing first content submitted by a first subscriber relating to a second subscriber;
a publishing subsystem configured to publish the first content based on an election to publish by the second subscriber; and
a scoring subsystem configured to calculate a score for the on-line profile of one or more of the first subscriber and the second subscriber based at least in part on the election made by the second subscriber.

13. The system of claim 12, wherein the first content relates to an interaction between the first subscriber and the second subscriber.

14. The system of claim 12, wherein the first content relates to a pre-defined personality trait of the second subscriber provided by the open, on-line user network site, and the score for the second on-line profile relates to the personality trait.

15. The system of claim 12, wherein the score comprises one or more of a self-awareness metric, an impression score, integrity metric, transparency metric, trust metrics, and reliability metric.

16. The system of claim 12, wherein the publishing system is further configured to publish the calculated score via the open, on-line user network site

17. A method comprising:
receiving, by a computer, first content submitted by a first subscriber having a first on-line profile associated with an open, on-line user network site, wherein the first content relates to characteristics of the first subscriber;
receiving an access request from a second subscriber having a second on-line profile associated with the open, on-line user network site, wherein the access request relates to the first on-line profile;
selectively granting access to the second subscriber in response to the access request and based upon a comparison between a score associated with the second on-line subscriber and a threshold score associated with the first on-line profile; and
generating a visual representation of the first content overlaid with second content relating to characteristics of the second subscriber.

18. The method of claim 17, wherein the first subscriber is an employer and the first content relates to a job posting.

19. The method of claim 17, wherein the first content comprises a pre-defined personality trait provided by the open, on-line user network site.

20. The method of claim 17, wherein selectively granting access comprises allowing the second subscriber to apply for the job posting.
